(19) United States
(12) Patent Application Publication
(10) Pub. No.: US 2024/0326436 A1
(43) Pub. Date: Oct. 3, 2024

(54) Method Of Manufacturing Liquid Ejecting Head

(71) Applicant: SEIKO EPSON CORPORATION, Tokyo (JP)

(72) Inventors: Masahiro FUJII, Shiojiri (JP); Koji KITAHARA, Ina (JP); Shinichi YOTSUYA, Chino (JP); Motoki TAKABE, Shiojiri (JP)

(21) Appl. No.: 18/617,728

(22) Filed: Mar. 27, 2024

(30) Foreign Application Priority Data
Mar. 28, 2023 (JP) 2023-051085

(51) Int. Cl. B41J 2/16; B41J 2/14

(52) U.S. Cl. CPC B41J 2/1607; B41J 2/14201; B41J 2/1629; B41J 2/1631; B41J 2/164; B41J 2002/14306

(57) ABSTRACT

the method comprising: a first step of forming the narrowed portion by performing metal-assisted chemical etching in a state in which a metal film is formed at a surface of a first portion corresponding to the narrowed portion, the surface of the first portion being a part of a first surface of a semiconductor substrate, and the metal film is not formed at a surface of a second portion not corresponding to the narrowed portion, the surface of the second portion being a part of the first surface.

The present application is based on, and claims priority from JP Application Serial Number 2023-051085, filed Mar. 28, 2023, the disclosure of which is hereby incorporated by reference herein in its entirety.

### BACKGROUND

### 1. Technical Field

The present disclosure relates to a method of manufacturing a liquid ejecting head.

### 2. Related Art

Recently, an ink-jet printer has been attracting attention not only for printing uses but also as an apparatus capable of applying a material that can be liquefied to a desired position. An ink-jet printer includes a liquid ejecting head that ejects liquid. As a liquid ejecting head, a head known in related art ejects liquid with which pressure compartments are filled, from its nozzles, by causing piezoelectric elements to vibrate a diaphragm constituting a wall surface of the pressure compartments.

A liquid ejecting head disclosed in JP-A-2019-107902 includes an upper substrate and an intermediate substrate. A plurality of pressure compartments is formed in the upper substrate. The intermediate substrate is bonded to the lower surface of the upper substrate. A manifold and a plurality of communication holes are formed in the intermediate substrate. The manifold supplies ink to the plurality of pressure compartments via the plurality of communication holes. Each of the upper substrate and the intermediate substrate is formed of a silicon substrate.

A liquid ejecting head disclosed in JP-A-2007-331167 includes a cavity substrate and a reservoir substrate. A plurality of pressure compartments is formed in the cavity substrate. The reservoir substrate is bonded to the cavity substrate. A reservoir and supply ports are formed in the reservoir substrate. The reservoir supplies ink to the pressure compartments via the supply ports. The material of each of the cavity substrate and the reservoir substrate is monocrystalline silicon.

In the liquid ejecting head disclosed in JP-A-2019-107902 and JP-A-2007-331167, the pressure compartments, and the manifold or the reservoir configured to supply ink to the pressure compartments, are formed in substrates that are different from each other. Therefore, it is possible to make the size of each substrate smaller and thus make the size of the ejecting head smaller.

In order to achieve a further reduction in the size of an ejecting head and an increase in a liquid ejection speed, there is a need to increase an ejection amount per unit time or an ejection cycle. For this purpose, it is conceivable to make pressure compartments larger and reduce flow passage resistance. However, if flow passage resistance is reduced, attenuation of residual vibrations, which are vibrations remaining inside the nozzle, will take time. As a result, it will take long for a meniscus to stabilize at the tip of the nozzle. For this reason, there is a possibility of a decrease in ejection performance. To solve this issue, for example, it is conceivable to increase ink flow passage resistance by micro-fabricating a liquid flow passage provided between each pressure compartment and the manifold or the reservoir.

However, in reducing the size of an ejecting head, microfabrication of liquid flow passages is very difficult. For example, liquid flow passages are formed in a substrate by dry etching. In this case, since an inflow of an etching gas decreases as a processing depth increases, very long processing time is required. Alternatively, for example, liquid flow passages are formed in a substrate by anisotropic wet etching along crystal orientation of the substrate. In this case, it is difficult to control the aspect ratio of the liquid flow passage.

Therefore, it is difficult to form liquid flow passages with high fineness and manufacture a liquid ejecting head that is compact and offers excellent ejection performance.

### SUMMARY

Provided by a certain aspect of the present disclosure is a method of manufacturing a liquid ejecting head including a plurality of individual flow passages and a common flow passage, each of the plurality of individual flow passages including a pressure compartment extending in a first direction, a nozzle being in communication with one end of the pressure compartment, and a narrowed portion being in communication with an other end of the pressure compartment and extending in a second direction intersecting with the first direction and being smaller in sectional area than the pressure compartment, the common flow passage being in shared communication with the plurality of individual flow passages, the method comprising: a first step of forming the narrowed portion by performing metal-assisted chemical etching in a state in which a metal film is formed at a surface of a first portion corresponding to the narrowed portion, the surface of the first portion being a part of a first surface of a semiconductor substrate, and the metal film is not formed at a surface of a second portion not corresponding to the narrowed portion, the surface of the second portion being a part of the first surface.

### BRIEF DESCRIPTION OF THE DRAWINGS

FIG. 1 is a schematic diagram illustrating a configuration of a liquid ejecting apparatus according to a first embodiment.

FIG. 2 is an exploded perspective view of the liquid ejecting head illustrated in FIG. 1.

FIG. 3 is a cross-sectional view taken along the line III-III of FIG. 2.

FIG. 4 is a plan view of a communication plate illustrated in FIG. 3.

FIG. 5 is an enlarged view of a part of the communication plate illustrated in FIG. 4.

FIG. 6 is a diagram illustrating a flow of a method of manufacturing the communication plate illustrated in FIG. 3.

FIG. 7 is a diagram illustrating a flow of a first step illustrated in FIG. 6.

FIG. 8 is a diagram for explaining a process from an oxide film forming step to a resist layer patterning step illustrated in FIG. 7.

FIG. 9 is a diagram for explaining a process from an oxide film etching step to a metal-assisted chemical etching step illustrated in FIG. 7.

FIG. 10 is a diagram for explaining the metal-assisted chemical etching step.

FIG. 11 is a diagram illustrating a flow of a second step illustrated in FIG. 6.

FIG. 12 is a diagram for explaining a process from a second oxide film forming step to a second resist layer patterning step illustrated in FIG. 11.

FIG. 13 is a diagram for explaining a process from a second oxide film etching step to a metal-assisted chemical etching step illustrated in FIG. 11.

FIG. 14 is a diagram for explaining the first step according to a second embodiment.

FIG. 15 is a diagram illustrating a flow of the second step according to the second embodiment.

FIG. 16 is a diagram for explaining the second step according to the second embodiment.

FIG. 17 is a diagram illustrating a flow of a method of manufacturing a communication plate according to a third embodiment.

FIG. 18 is a diagram illustrating a flow of a third step according to the third embodiment.

FIG. 19 is a diagram for explaining the third step according to the third embodiment.

FIG. 20 is a diagram for explaining the third step according to the third embodiment.

FIG. 21 is a diagram illustrating a flow of a method of manufacturing a liquid ejecting head.

FIG. 22 is a table for explaining examples of a narrowed portion illustrated in FIG. 5.

### DESCRIPTION OF EMBODIMENTS

### 1. First Embodiment

### 1-1. Overall Configuration of Liquid Ejecting Apparatus 1

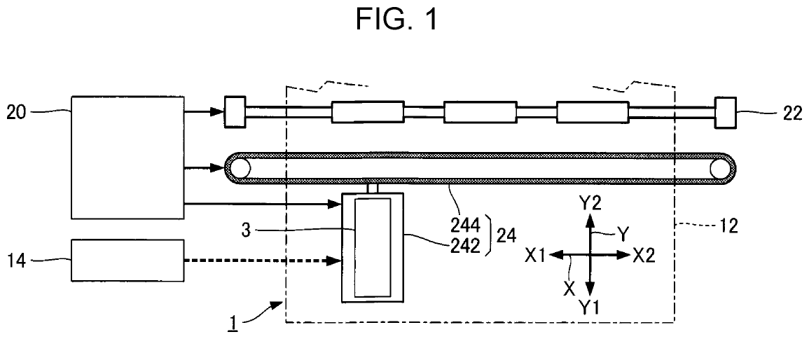

FIG. 1 is a diagram illustrating a configuration of a liquid ejecting apparatus 1 according to a first embodiment. For the sake of explanation, the description below will be given with reference to X, Y, and Z axes orthogonal to one another. One direction along the X axis is denoted as “X1 direction”. The direction that is the opposite of the X1 direction is denoted as “X2 direction”. Similarly, one direction along the Y axis is denoted as “Y1 direction”, and the direction that is the opposite of the Y1 direction is denoted as “Y2 direction”. One direction along the Z axis is denoted as “Z1 direction”, and the direction that is the opposite of the Z1 direction is denoted as “Z2 direction”.

The meaning of “an element α and an element β are in communication with each other” includes not only a case where the element α and the element β are directly in communication with each other but also a case where the element α and the element β are indirectly in communication with each other via another element. The meaning of “an element β on an element α” is not limited to a configuration in which the element α and the element β are directly in contact with each other but also a configuration in which the element α and the element β are not directly in contact with each other.

The liquid ejecting apparatus 1 is an ink-jet-type printing apparatus that ejects ink, which is an example of a liquid, onto a medium 12. A typical example of the medium 12 is printing paper. However, a print target made of any material such as a resin film, a cloth, or the like can be used as the medium 12. As illustrated in FIG. 1, a liquid container(s) 14 containing ink is provided on the liquid ejecting apparatus 1. For example, a cartridge that can be detachably attached to the liquid ejecting apparatus 1, a bag-type ink pack made of a flexible film material, or an ink tank that can be refilled with ink is used as the liquid container 14.

The liquid ejecting apparatus 1 includes a control unit 20, a transport mechanism 22, a movement mechanism 24, and a liquid ejecting head 3. The control unit 20 includes one or more processing circuits, for example, CPUs (central processing units) or FPGAs (field programmable gate arrays), and one or more storage circuits such as semiconductor memories, etc. The control unit 20 performs central control on elements of the liquid ejecting apparatus 1. The transport mechanism 22 transports the medium 12 in the direction that is along the Y axis under the control of the control unit 20.

The movement mechanism 24 reciprocates the liquid ejecting head 3 under the control of the control unit 20. The X axis intersects with the Y axis, which is along the direction of transportation of the medium 12. The movement mechanism 24 according to the first embodiment includes a substantially-box-type carriage 242, which houses the liquid ejecting head 3, and a transport belt 244, to which the carriage 242 is fixed. A configuration in which a plurality of liquid ejecting heads 3 is mounted on the carriage 242 or a configuration in which the liquid container 14 is mounted together with the liquid ejecting head 3 on the carriage 242 can also be adopted.

The liquid ejecting head 3 ejects ink supplied from the liquid container 14 onto the medium 12 from a plurality of nozzles under the control of the control unit 20. Concurrently with the transportation of the medium 12 by the transport mechanism 22 and the repetitive reciprocation of the carriage 242, each liquid ejecting head 3 ejects ink onto the medium 12, thereby forming an image on the surface of the medium 12.

### 1-2. Overall Configuration of Liquid Ejecting Head 3

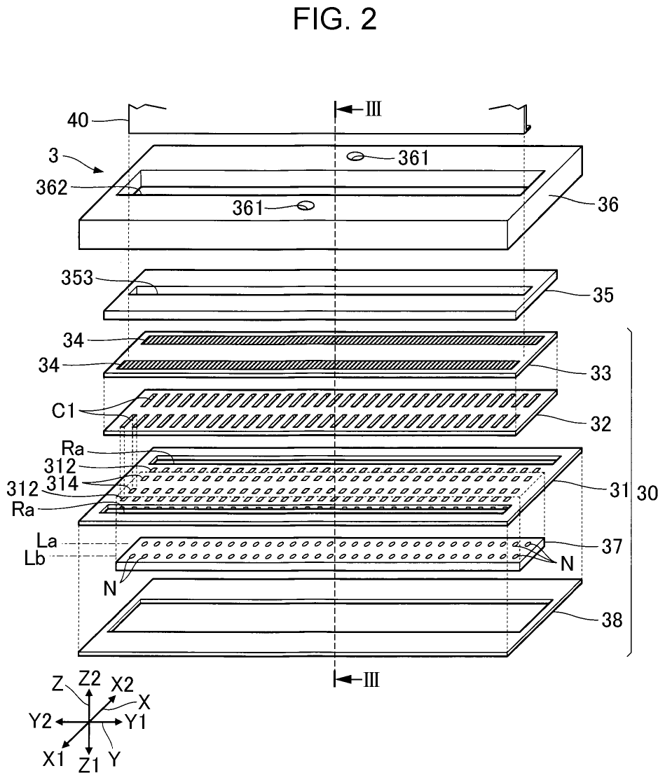

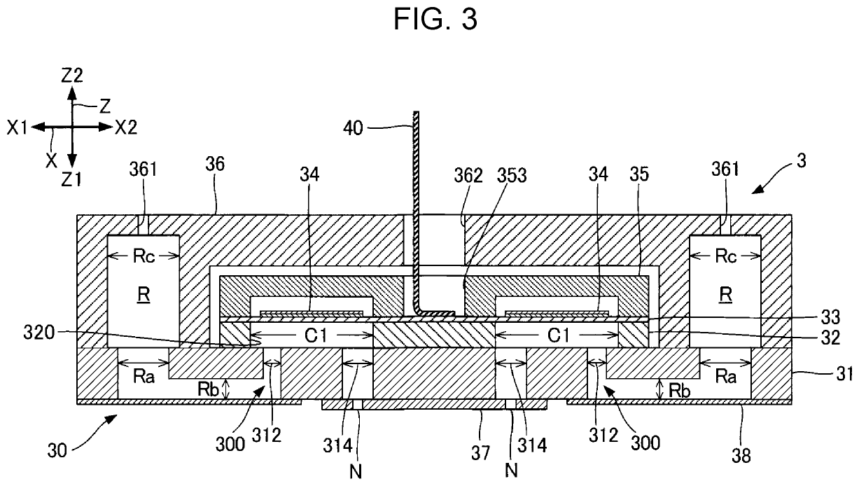

FIG. 2 is an exploded perspective view of the liquid ejecting head 3 illustrated in FIG. 1. FIG. 3 is a cross-sectional view taken along the line III-III of FIG. 2. The section illustrated in FIG. 3 is a section parallel to an X-Z plane. The Z axis is an axis extending in the direction in which ink is ejected by the liquid ejecting head 3. The X1 direction or the X2 direction is an example of “first direction”. The Z2 direction is an example of “second direction”. View in the Z1 direction or the Z2 direction will be referred to as “plan view”.

As illustrated in FIG. 2, the liquid ejecting head 3 includes a plurality of nozzles N arranged along the Y axis. The plurality of nozzles N is grouped into a first row La and a second row Lb, which are arranged next to each other, with an X-directional space therebetween. Each of the first row La and the second row Lb is a group of nozzles N arranged linearly along the Y axis. The liquid ejecting head 3 has a structure in which elements related to nozzles N of the first row La and elements related to nozzles N of the second row Lb are arranged in a substantially plane-symmetrical manner. The nozzles N belonging to the first row La are arranged in a line at a density of, for example, 300 dpi. Similarly, the nozzles N belonging to the second row Lb are arranged in a line at a density of, for example, 300 dpi. The nozzles N belonging to the second row Lb are arranged with a shift of, for example, 600 dpi with respect to the nozzles N belonging to the first row La. In the description below, the elements corresponding to the first row La will be mainly explained, and an explanation of the elements corresponding to the second row Lb will be omitted where appropriate.

As illustrated in FIGS. 2 and 3, the liquid ejecting head 3 includes a flow passage structure body 30, a plurality of piezoelectric elements 34, a sealing substrate 35, a casing portion 36, and a wiring substrate 40.

The flow passage structure body 30 is a structure body inside which flow passages for supplying ink to the plurality of nozzles N respectively are formed. The flow passage structure body 30 is made up of a communication plate 31, a pressure compartment substrate 32, a diaphragm 33, a nozzle substrate 37, and a vibration absorber 38.

Each of the members constituting the flow passage structure body 30 is an elongated plate-like member extending along the Y axis. The pressure compartment substrate 32 and the casing portion 36 are disposed on the Z2-side surface of the communication plate 31. The nozzle substrate 37 and the vibration absorber 38 are disposed on the Z1-side surface of the communication plate 31. The members are fixed to each other using, for example, an adhesive.

The nozzle substrate 37 is a plate-like member in which the plurality of nozzles N is formed. Each of the plurality of nozzles N is a circular through hole through which ink is ejected. The nozzle substrate 37 is manufactured by, for example, processing a monocrystalline substrate made of silicon (Si) by using a semiconductor manufacturing technology such as photolithography and etching, etc.

A plurality of narrowed portions 312, a plurality of communication flow passages 314, a communication space Ra, and a common flow passage Rb are formed in the communication plate 31. Each of the narrowed portion 312 and the communication flow passage 314 is a through hole extending in the Z1 direction and formed individually for each of the nozzles N. The communication flow passage 314 overlaps with the nozzle N in a plan view. The communication space Ra is an elongated opening extending along the Y axis. The communication space Ra extends along the Y axis. The common flow passage Rb is in communication with the communication space Ra and overlaps with the communication space Ra in a plan view. The common flow passage Rb extends along the Y axis. The common flow passage Rb is in communication with the plurality of narrowed portions 312. The communication space Ra communicates the common flow passage Rb with an external flow passage outside the liquid ejecting head 3 via a space Rc to be described later.

A plurality of pressure compartments C1 is formed in the pressure compartment substrate 32. The pressure compartment C1 is a space located between the communication plate 31 and the diaphragm 33 and formed by wall surfaces 320 of the pressure compartment substrate 32. The pressure compartment C1 is formed individually for each of the nozzles N. The pressure compartment C1 is an elongated space extending in the X1 direction. The plural pressure compartments C1 are arranged along the Y axis. The nozzle N is in communication with one end in the X1 direction of the pressure compartment C1 via the communication flow passage 314. The narrowed portion 312 is in communication with the other end in the X1 direction of the pressure compartment C1. The cross-sectional area of the narrowed portion 312 is smaller than that of the pressure compartment C1. The pressure compartment C1, the nozzle N, the communication flow passage 314, and the narrowed portion 312 constitute an individual flow passage 300 for each of the nozzles N. Providing the communication flow passage 314 and the narrowed portion 312 on the Z1-directional side with respect to the pressure compartment C1 makes it possible to achieve high-density nozzle arrangement, resulting in small size and high density of the liquid ejecting head 3.

The communication plate 31 and the pressure compartment substrate 32 are manufactured by, for example, processing a monocrystalline substrate made of silicon or the like.

The diaphragm 33, which is elastically deformable, is disposed over the pressure compartment C1. The diaphragm 33 is stacked on the pressure compartment substrate 32 and is in contact with the surface of the pressure compartment substrate 32 that is the opposite of the surface facing the communication plate 31. The diaphragm 33 is a rectangular plate-like member whose longer sides extend along the Y axis in a plan view. The thickness direction of the diaphragm 33 is parallel to the Z1 direction. The pressure compartment C1 is in communication with the communication flow passage 314 and the narrowed portion 312. Therefore, the pressure compartment C1 is in communication with the nozzle N via the communication flow passage 314 and is in communication with the communication space Ra via the narrowed portion 312. Though the pressure compartment substrate 32 and the diaphragm 33 are illustrated as separate substrates in FIG. 2 for easier understanding, they are actually layered in a single silicon substrate.

The piezoelectric element 34 is formed individually for each of the pressure compartments C1 on the surface of the diaphragm 33 that is the opposite of the surface facing the pressure compartment C1. The piezoelectric element 34 is an elongated passive element extending along the X axis in a plan view. The piezoelectric element 34 is an example of an energy generation element that generates energy for ejecting ink when a drive signal is applied. Though a piezoelectric element that generates mechanical energy is described as the energy generation element here, an electro-thermal conversion element that generates thermal energy may be used as long as the system includes the diaphragm 33. The piezoelectric element 34 behaves also as a drive element that operates when a drive signal is applied.

The casing portion 36 is a case for pooling ink to be supplied to the plurality of pressure compartments C1 and is formed by, for example, injection molding of a resin material. The space Rc and supply inlet 361 are formed in the casing portion 36. The supply inlet 361 is a conduit passage to which ink is supplied from the liquid container 14. The supply inlet 361 is in communication with the space Rc. The space Rc of the casing portion 36 and the communication space Ra of the communication plate 31 are in communication with each other. The communication space Ra, the common flow passage Rb, and the space Rc described above constitute a common space R shared by the plurality of nozzles N. The common space R functions as a liquid reservoir that pools ink to be supplied to the plurality of pressure compartments C1. The ink pooled in the common space R flows while forming a branch into each of the narrowed portions 312 and is then supplied to the plurality of pressure compartments C1 in parallel to fill them.

The vibration absorber 38 is a flexible film that constitutes a wall surface of the communication space Ra, and absorbs pressure fluctuations of ink inside the common space R. The vibration absorber 38 is, for example, a stacked body made up of an ink-resistant resin film, a stainless steel (SUS) member protecting the resin film and having elasticity, and a fixing plate protecting the resin film and the SUS member. Providing the vibration absorber 38 makes a natural frequency of the individual flow passage 300 from the nozzle N to the narrowed portion 312 via the pressure compartment C1 stable irrespective of the nozzle N driven.

The sealing substrate 35 is a structural member that protects the plurality of piezoelectric elements 34 and reinforces the mechanical strength of the pressure compartment substrate 32 and the diaphragm 33, and is bonded to the surface of the diaphragm 33 by means of, for example, an adhesive. The plurality of piezoelectric elements 34 is housed inside a recessed portion formed in, of the sealing substrate 35, the surface facing the diaphragm 33. The wiring substrate 40 is inserted in a through hole 362 of the casing portion 36 and a through hole 353 of the sealing substrate 35. The wiring substrate 40 is bonded to the surface of the diaphragm 33. The wiring substrate 40 is a mount component on which a plurality of wiring lines for electric coupling between the control unit 20 and the liquid ejecting head 3 is formed. For example, a tape carrier package (TCP), a flexible printed circuit (FPC), or the like is used as the wiring substrate 40. To each of the piezoelectric elements 34, a drive signal for driving the piezoelectric element 34 and a reference voltage are supplied from the wiring substrate 40.

In the liquid ejecting head 3 having the above structure, when the piezoelectric element 34 contracts due to electric energization, the diaphragm 33 deforms in a curved manner in a direction of decreasing the capacity of the pressure compartment C1, and this causes an increase in internal pressure of the pressure compartment C1, resulting in ejection of an ink droplet from the nozzle N. At this time, the pressure propagates from the pressure compartment C1 toward the narrowed portion 312, too, and ink flows through the narrowed portion 312 to the common flow passage Rb, too. The piezoelectric element 34 returns to its original position after the ink ejection. When this occurs, ink from the nozzle N to the common flow passage Rb also vibrates. Then, ink is supplied from the narrowed portion 312 concurrently with the restoration of the meniscus of the nozzle N. Ink is ejected from the nozzle N through a series of the above-described operations.

### 1-3. Communication Plate 31

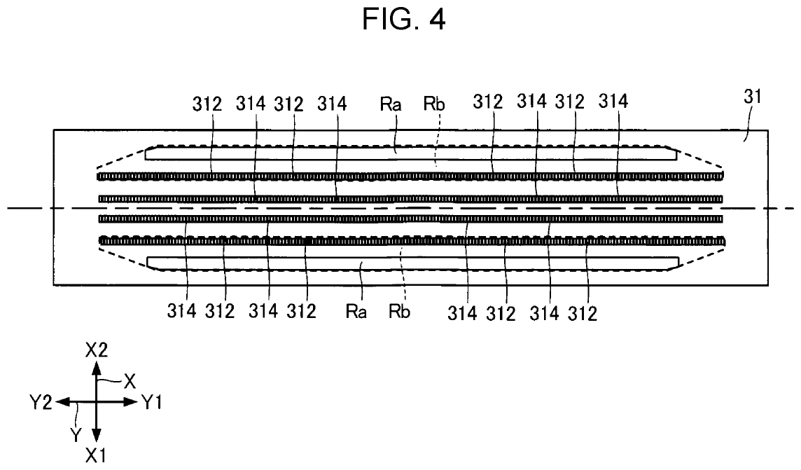

FIG. 4 is a plan view of the communication plate 31 illustrated in FIG. 3. As illustrated in FIG. 4, the communication space Ra, the common flow passage Rb, the plurality of narrowed portions 312, and the plurality of communication flow passages 314 are formed in the communication plate 31. The communication space Ra extends in the Y1 direction. The common flow passage Rb extends in the Y1 direction and overlaps with the communication space Ra and the plurality of narrowed portions 312 in a plan view. Each of the plurality of narrowed portions 312 and each of the plurality of communication flow passages 314 are, for example, provided in a one-to-one corresponding manner for each of the plurality of nozzles N. Two or more narrowed portions 312 may correspond to one nozzle N. The plural narrowed portions 312 are spaced apart from one another and are arranged in the Y1 direction. The plural communication flow passages 314 are spaced apart from one another and are arranged in the Y1 direction. In addition, the plural communication flow passages 314 are spaced apart from the common flow passage Rb and the plurality of narrowed portions 312.

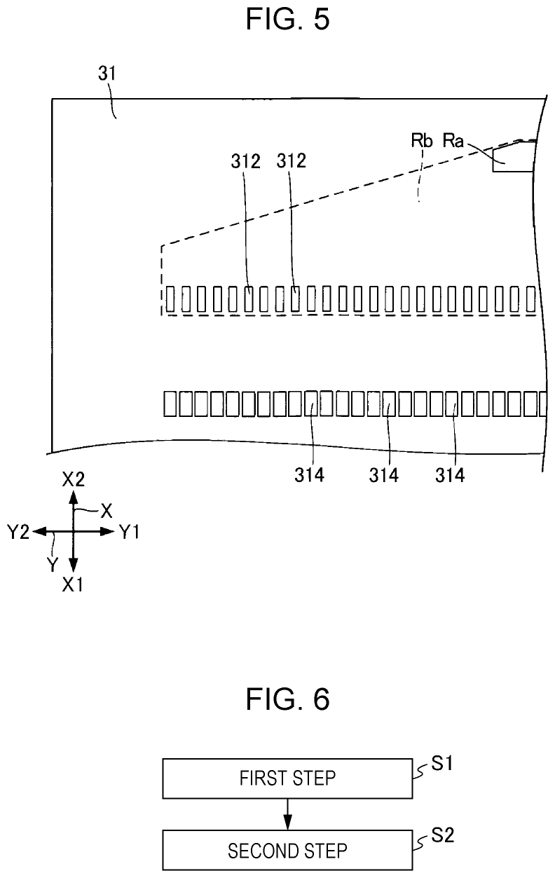

FIG. 5 is an enlarged view of a part of the communication plate 31 illustrated in FIG. 4. As illustrated in FIG. 5, the cross-sectional area of the narrowed portion 312 parallel to an X-Y plane is smaller than the cross-sectional area of the communication flow passage 314 parallel to the X-Y plane. In addition, the cross-sectional area of the narrowed portion 312 parallel to the X-Y plane is smaller than the cross-sectional area of the common flow passage Rb along the Z axis. In addition, the shape, etc. of the common flow passage Rb is designed such that the plurality of narrowed portions 312 has an equal flow passage resistance in relation to one another.

When a series of the above-described ink ejecting operations is performed, in the individual flow passage 300 illustrated in FIG. 3, vibrations caused in the process of ejecting ink attenuate due to a flow passage resistance inside the individual flow passage 300. The flow passage resistance inside the individual flow passage 300 is mainly caused by a flow passage resistance of the narrowed portion 312. This is because the cross-sectional area of the narrowed portion 312 parallel to the X-Y plane is smaller than each of the cross-sectional area of the common flow passage Rb parallel to the Z axis and the cross-sectional area of the pressure compartment C1 along the Z axis. It is possible to adjust the flow passage resistance inside the individual flow passage 300 by adjusting the number of the narrowed portions 312 and the cross-sectional area thereof. For this reason, the narrowed portion 312 functions as a fluid resistance portion.

Moreover, the narrowed portion 312 can be regarded also as a supply port through which ink is supplied from the common flow passage Rb into the individual flow passage 300. Since the narrowed portion 312, which is such a supply port, functions as a fluid resistance portion, there is no need to provide a fluid resistance portion in the pressure compartment C1. Therefore, it is possible to make the size of the pressure compartment C1 smaller and thus make the size of the liquid ejecting head 3 smaller. Moreover, since there is no need to provide a fluid resistance portion in the pressure compartment C1, it is easier to increase the length of the piezoelectric element 34 without changing the capacity of the pressure compartment C1. For this reason, it is possible to increase the performance of ejecting ink without causing an increase in size of the liquid ejecting head 3. Therefore, it is possible to make the size of the liquid ejecting head 3 smaller and make the speed thereof higher.

Moreover, since the communication plate 31 is provided on the Z1-directional side with respect to the pressure compartment substrate 32, it is possible to provide the narrowed portions 312 on the Z1-directional side with respect to the pressure compartments C1. For this reason, it is easier to increase the number of the narrowed portions 312 and the cross-sectional area thereof for the purpose of adjusting the flow passage resistance.

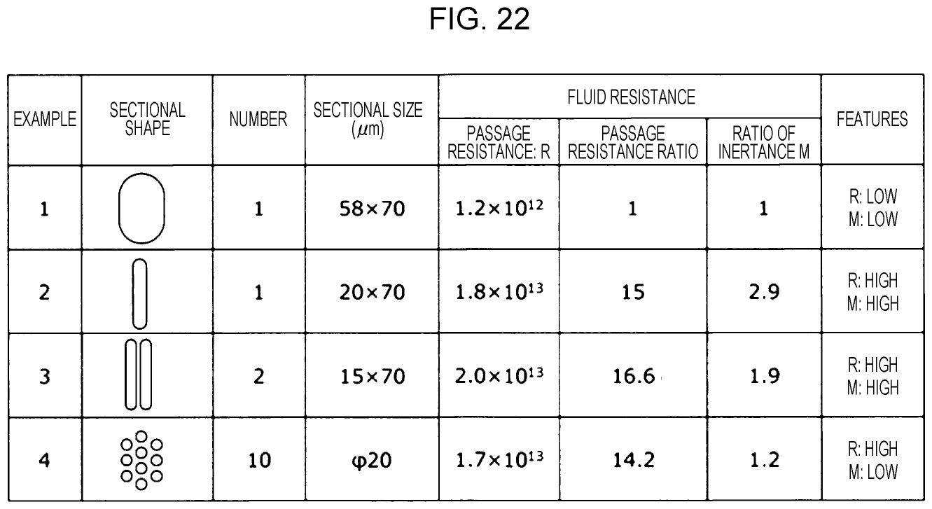

FIG. 22 is a table for explaining examples of the narrowed portion 312 illustrated in FIG. 5. In FIG. 22, the cross-sectional shape of the narrowed portion 312, the number of the narrowed portions 312 corresponding to one nozzle N, the cross-sectional size of the narrowed portion 312, and the fluid resistance in the narrowed portion 312 are illustrated for each example.

The fluid resistance can be calculated from the length of the narrowed portion 312 in the Z1 direction in relation to the cross-sectional shape of the narrowed portion 312 along an X-Y plane and from physical properties such as ink viscosity, density, and the like. The fluid resistance includes a flow passage resistance, a flow passage resistance ratio, and an inertance ratio. The calculation results are illustrated in FIG. 22. The flow passage resistance is denoted as R. The inertance is denoted as M. The calculation was conducted with the length of the narrowed portion 312 in the Z1 direction set as 200 μm. The unit of the flow passage resistance is [N·s/m²].

Striking a balance between the flow passage resistance of the narrowed portion 312 and the fluid resistance of the nozzle N is most efficient for ink ejection. For this reason, the cross-sectional size of the narrowed portion 312 is set in such a way as to make the flow passage resistance of the narrowed portion 312 and the fluid resistance of the nozzle N approximately equal to each other. The fluid resistance of the nozzle N, specifically, the flow passage resistance at the opening in the Z1 direction of the nozzle N, is Rn=8.7×1012 [N·s/m²]. The results of setting the cross-sectional size of the narrowed portion 312 in such a way as to make the fluid resistance of the narrowed portion 312 close to this value are illustrated for each example. The viscosity of ink at 25° C. when set in this way is: η25=3.36×10⁻³ [Pa/s].

The cross-sectional size of the narrowed portion 312 of the first example is larger than that of the other examples. For this reason, the fluid resistance, the flow passage resistance ratio, and the inertance ratio of the narrowed portion 312 are the lowest. Therefore, it is possible to make the frequency of ink ejection highest, specifically, the number of droplets that can be ejected per nozzle N per 1 sec. However, since the flow passage resistance is low, the attenuation of residual vibrations is weak. For this reason, it is sometimes difficult for residual vibrations of ink inside the pressure compartment C1 to subside soon. Consequently, there is a possibility of unstable ink ejection.

In view of the above disadvantage of the first example, in the second example, the cross-sectional size of the narrowed portion 312 is configured to be smaller than that of the first example. Specifically, the flow passage resistance of ink in the second example is set to be fifteen times as high as that in the first example. In the second example, it is possible to perform more stable ink ejection than in the first example. On the other hand, in the second example, the inertance is greater than in the first example. For this reason, in the second example, the frequency of ink ejection is lower than in the first example.

In the third example, two narrowed portions 312 each having a shape similar to that of the narrowed portion 312 according to the second example are provided in parallel. In the third example, as compared with the second example, it is possible to suppress an increase in inertance in relation to an increase in flow passage resistance. Increasing the number of the narrowed portions 312 makes it possible to increase the flow passage resistance. For this reason, it is possible to enhance the performance of attenuating residual vibrations inside the pressure compartment C1 after ink ejection. Therefore, it is possible to keep the frequency of ink ejection high.

In the fourth example, the number of the narrowed portions 312 is further increased in comparison with the third example. An optimum design of the narrowed portion 312 is achieved by further increasing the number of the narrowed portions 312.

It is possible to optimize the fluid resistance of the narrowed portion 312 by increasing the number of the narrowed portions 312 corresponding to one nozzle N as illustrated in FIG. 22. Therefore, the liquid ejecting head 3 that offers excellent ejection performance can be realized. On the other hand, disadvantageous aspects are difficult processing of the narrowed portions 312 and difficult implementation.

### 1-4. Method of Manufacturing Communication Plate 31

FIG. 6 is a diagram illustrating a flow of a method of manufacturing the communication plate 31 illustrated in FIG. 3. The liquid ejecting head manufacturing method includes a method of manufacturing the communication plate 31. As illustrated in FIG. 6, the method of manufacturing the communication plate 31 includes a first step S1 and a second step S2. In the first step S1, as will be described later, metal-assisted chemical etching is used. Metal-assisted chemical etching is abbreviated as MACE. Using metal-assisted chemical etching makes it possible to realize the narrowed portion 312 that has a structure that has been difficult to be processed according to related-art methods. The method of manufacturing the communication plate 31 includes a method of manufacturing the narrowed portion 312.

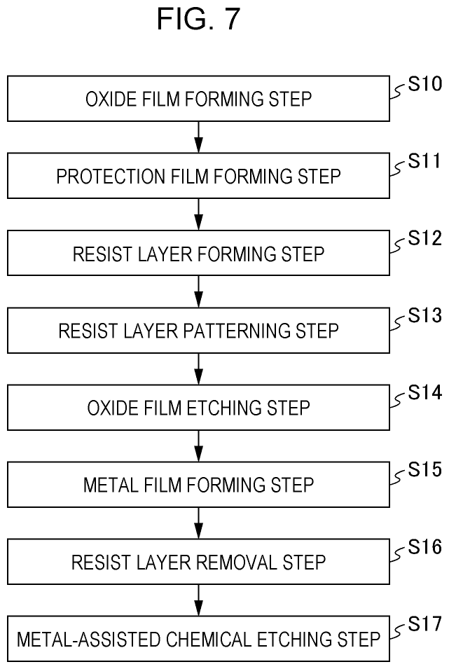

FIG. 7 is a diagram illustrating a flow of the first step S1 illustrated in FIG. 6. As illustrated in FIG. 7, the first step S1 includes an oxide film forming step S10, a protection film forming step S11, a resist layer forming step S12, a resist layer patterning step S13, an oxide film etching step S14, a metal film forming step S15, a resist layer removal step S16, and a metal-assisted chemical etching step S17.

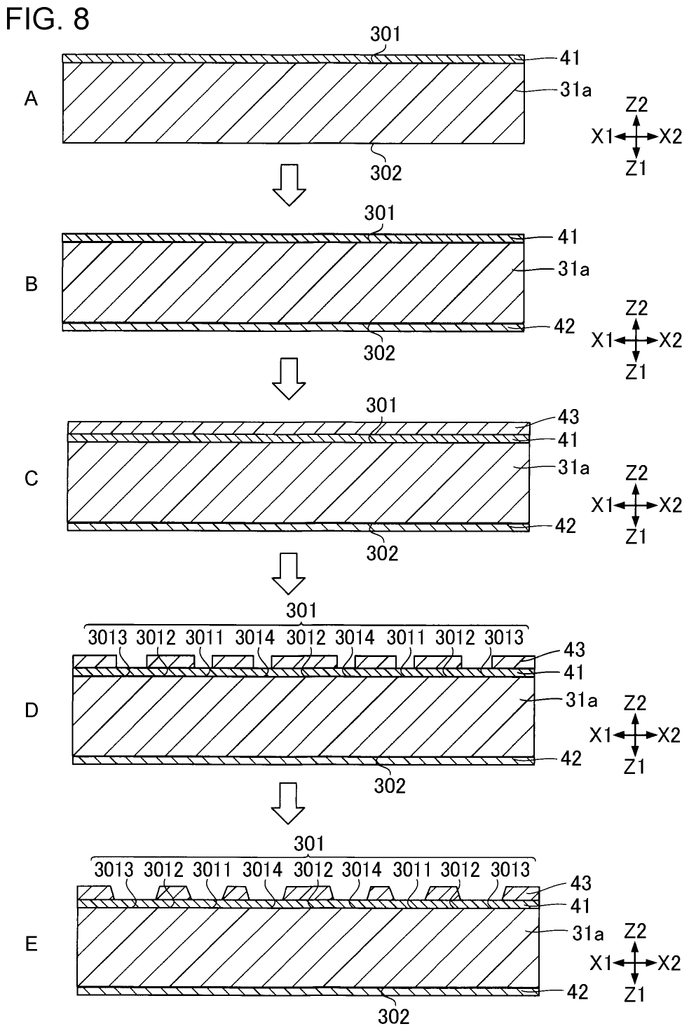

FIG. 8 is a diagram for explaining a process from the oxide film forming step S10 to the resist layer patterning step S13 illustrated in FIG. 7. First, for example, a semiconductor substrate 31a such as a 100-crystal-oriented N-type monocrystalline silicon substrate is prepared as a parent material of the communication plate 31. The semiconductor substrate 31a includes a first surface 301 and a second surface 302. The second surface 302 is the surface that is the opposite of the first surface 301.

In FIG. 8, A is a diagram for explaining the oxide film forming step S10. As illustrated in A of FIG. 8, in the oxide film forming step S10, an oxide film 41 is formed at the first surface 301 of the semiconductor substrate 31a. Specifically, the oxide film 41 is a silicon oxide film. For example, the oxide film 41 is formed using a chemical vapor deposition (CVD) method or a thermal oxidation method. The thickness of the oxide film 41, though not specifically limited, is, for example, 0.02 μm or greater and 0.2 μm or less.

In FIG. 8, B is a diagram for explaining the protection film forming step S11. As illustrated in B of FIG. 8, in the protection film forming step S11, a protection film 42 is formed at the second surface 302 of the semiconductor substrate 31a. The protection film 42 is made of, for example, diamond-like carbon or the like. Diamond-like carbon is abbreviated as DLC. For example, the protection film 42 is formed using a CVD method or a sputtering method.

In FIG. 8, C is a diagram for explaining the resist layer forming step S12. As illustrated in C of FIG. 8, in the resist layer forming step S12, a resist layer 43 is formed at the first surface 301 of the semiconductor substrate 31a. Specifically, the resist layer 43 is formed on the oxide film 41 formed on the first surface 301. A resist is applied onto the oxide film 41, and the resist layer 43 is formed on the oxide film 41 by using a centrifugal force. The thickness of the resist layer 43, though not specifically limited, is, for example, 1 μm or greater and 3 μm or less.

In FIG. 8, each of D and E is a diagram for explaining the resist layer patterning step S13. As illustrated in D of FIG. 8, in the resist layer patterning step S13, the resist layer 43 is patterned by removing a part of the resist layer 43.

The first surface 301 of the semiconductor substrate 31a includes a first portion 3011, a second portion 3012, a third portion 3013, and a sixth portion 3014. The first portion 3011 is a portion corresponding to the narrowed portions 312. The third portion 3013 is a portion corresponding to the communication space Ra. The sixth portion 3014 is a portion corresponding to the communication flow passages 314. The second portion 3012 is a portion not corresponding to the narrowed portions 312, not to the communication flow passages 314, nor to the communication space Ra. The first portion 3011, the third portion 3013, and the sixth portion 3014 are portions to be removed by metal-assisted chemical etching to be described later. The second portion 3012 is a portion not to be removed by metal-assisted chemical etching.

In the resist layer patterning step S13, the resist layer 43 is patterned in such a way as to form an opening at the first portion 3011, the third portion 3013, and the sixth portion 3014 and not to form an opening at the second portion 3012.

As illustrated in E of FIG. 8, reflow baking is performed after the patterning of the resist layer 43. As a result of this baking, the resist layer 43 having been patterned is narrower at its Z2-side surface than at its Z1-side surface due to surface tension.

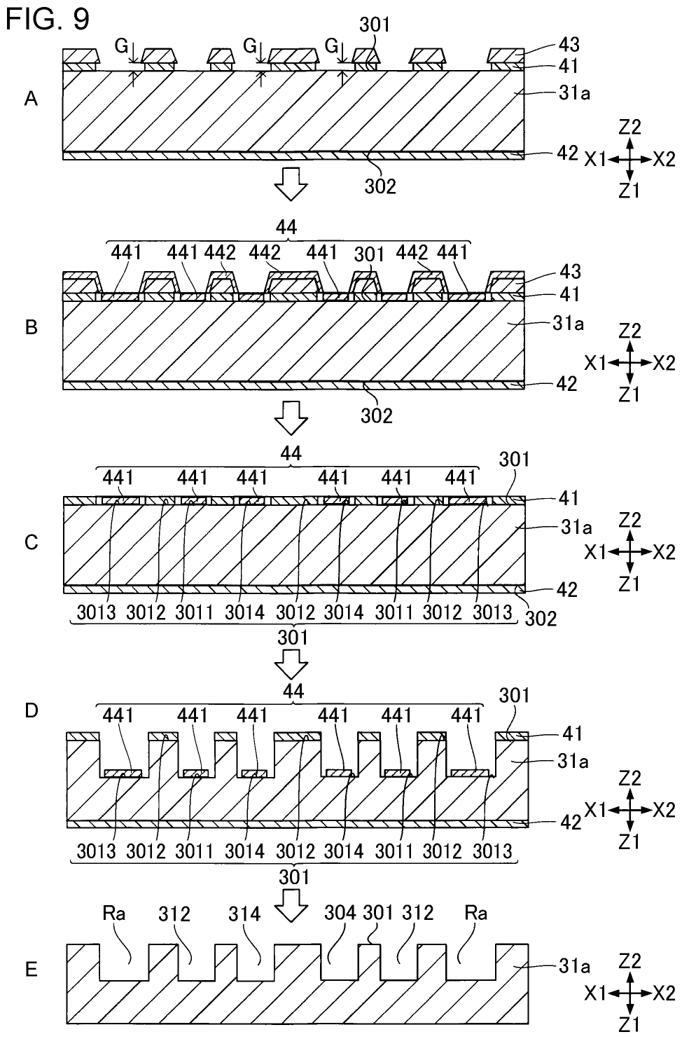

FIG. 9 is a diagram for explaining a process from the oxide film etching step S14 to the metal-assisted chemical etching step S17 illustrated in FIG. 7.

In FIG. 9, A is a diagram for explaining the oxide film etching step S14. As illustrated in A of FIG. 9, in the oxide film etching step S14, the oxide film 41 is patterned by etching a part of the oxide film 41 away. For example, a part of the oxide film 41 is removed by wet etching using buffered hydrofluoric acid, with the resist layer 43 serving as a mask. Buffered hydrofluoric acid is abbreviated as BHF.

In the oxide film etching step S14, a gap G is formed between the first surface 301 and the resist layer 43. That is, in the oxide film etching step S14, a part of the oxide film 41 is removed to such an extent that the gap G is formed. In particular, when the semiconductor substrate 31a contains silicon, performing wet etching using hydrofluoric acid makes it easier to form the gap G. Moreover, since the gap G is formed, the patterned oxide film 41 is covered by the patterned resist layer 43 in a plan view.

In FIG. 9, B is a diagram for explaining the metal film forming step S15. As illustrated in B of FIG. 9, in the metal film forming step S15, a metal film 44 is formed at the first surface 301 of the semiconductor substrate 31a. Specifically, the metal film 44 is formed on the resist layer 43 at the first surface 301. For example, film deposition of the metal film 44 is performed using a sputtering method or the like. The metal film 44 contains, for example, platinum, ruthenium, gold, palladium, molybdenum, chromium, copper, tantalum, titanium, or iridium.

As described above, the gap G is formed between the first surface 301 and the resist layer 43. For this reason, the metal film 44 includes a portion(s) 441 that is in contact with the first surface 301 and a portion(s) 442 that is in contact with the resist layer 43. Since the gap G is provided, the portion 441 is not continuous to the portion 442 and is thus separated therefrom.

In FIG. 9, C is a diagram for explaining the resist layer removal step S16. As illustrated in C of FIG. 9, in the resist layer removal step S16, the resist layer 43 is removed. Simultaneously with this removal, the portion 442, of the metal film 44, located on and in contact with the resist layer 43 is also removed. As a result of this removal, the metal film 44 made up of a plurality of portions 441 is formed at the first surface 301.

The metal film 44 is formed on a surface at the first portion 3011, the third portion 3013, and the sixth portion 3014 and is not formed on a surface at the second portion 3012. Therefore, in a plan view, the metal film 44 overlaps with the first portion 3011, the third portion 3013, and the sixth portion 3014 and does not overlap with the second portion 3012. In addition, the metal film 44 is in contact with the first portion 3011, the third portion 3013, and the sixth portion 3014 and is not in contact with the second portion 3012.

In FIG. 9, each of D and E is a diagram for explaining the metal-assisted chemical etching step S17. As illustrated in D of FIG. 9, in the metal-assisted chemical etching step S17, a part of the semiconductor substrate 31a is removed by metal-assisted chemical etching. For example, metal-assisted chemical etching using a solvent containing hydrogen fluoride and an oxidizing agent is most suitable.

In metal-assisted chemical etching, oxidation of the semiconductor substrate 31a caused by a catalytic action of the material of the metal film 44, etching of an oxide of the semiconductor substrate 31a by the solvent, and attraction due to the Coulomb force of the metal film 44 and the semiconductor substrate 31a are repeated. It is possible to form a hole in the Z1 direction by repeating them.

As illustrated in E of FIG. 9, the metal film 44 is removed after the removal of a part of the semiconductor substrate 31a. In addition, the oxide film 41 is removed by, for example, wet etching using buffered hydrofluoric acid. The protection film 42 is removed by, for example, plasma ashing. As a result of this removal, each narrowed portion 312, a part of each communication flow passage 314, and the communication space Ra are formed in the semiconductor substrate 31a.

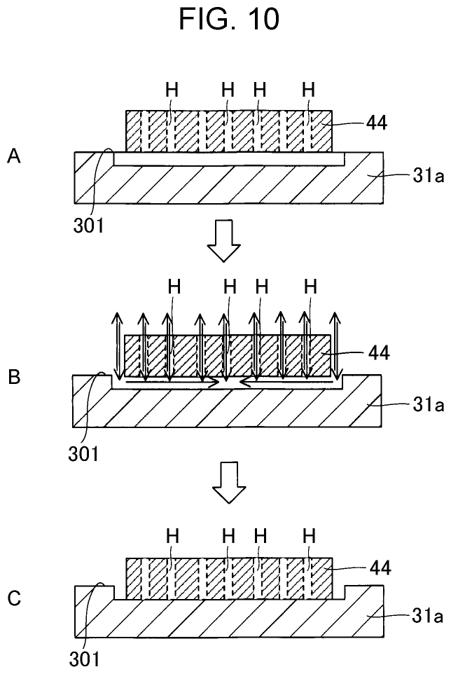

FIG. 10 is a diagram for explaining the metal-assisted chemical etching step S17. As illustrated in A of FIG. 10, the metal film 44 described above includes a plurality of through holes H. Each of the plurality of through holes H goes through the metal film 44 in the Z1 direction. The plurality of through holes H is provided by making the metal film 44 porous, and may be formed in the resist layer removal step S16 or may be formed in the metal film 44 formed in the metal film forming step S15. In the description of metal-assisted chemical etching below, a case where a solvent containing hydrogen fluoride and an oxidizing agent is used is taken as an example.

As illustrated in A of FIG. 10, hydrogen fluoride contained in the solvent reacts with the metal film 44, and the semiconductor substrate 31a oxidizes due to a catalytic action of the material of the metal film 44. As a result of this oxidation, an oxide of the semiconductor substrate 31a is formed. As indicated by a plurality of arrows in B of FIG. 10, the solvent moves along the plurality of through holes H of the metal film 44. The solvent enters the gap between the semiconductor substrate 31a and the metal film 44 from the through holes H. The oxide of the semiconductor substrate 31a is dissolved by the oxidizing agent contained in the solvent having entered the gap. As illustrated in C of FIG. 10, the metal film 44 is attracted to the semiconductor substrate 31a due to the Coulomb force of the metal film 44 and the semiconductor substrate 31a. Through repetition of states illustrated in A, B, and C of FIG. 10, a hole is formed in the Z1 direction.

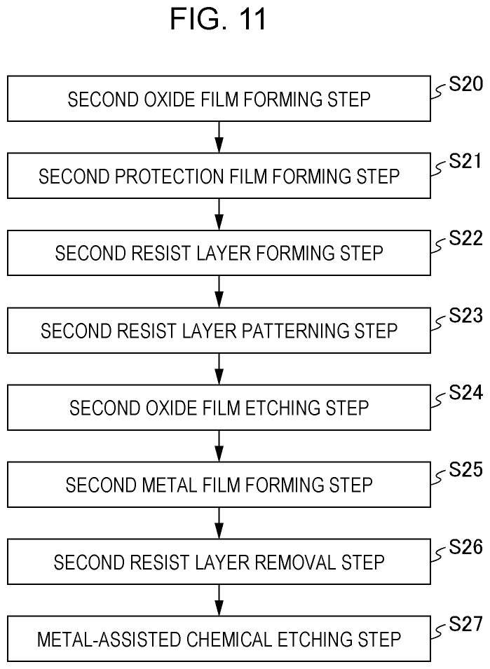

FIG. 11 is a diagram illustrating a flow of the second step S2 illustrated in FIG. 6. The second step S2 includes a second oxide film forming step S20, a second protection film forming step S21, a second resist layer forming step S22, a second resist layer patterning step S23, a second oxide film etching step S24, a second metal film forming step S25, a second resist layer removal step S26, and a metal-assisted chemical etching step S27.

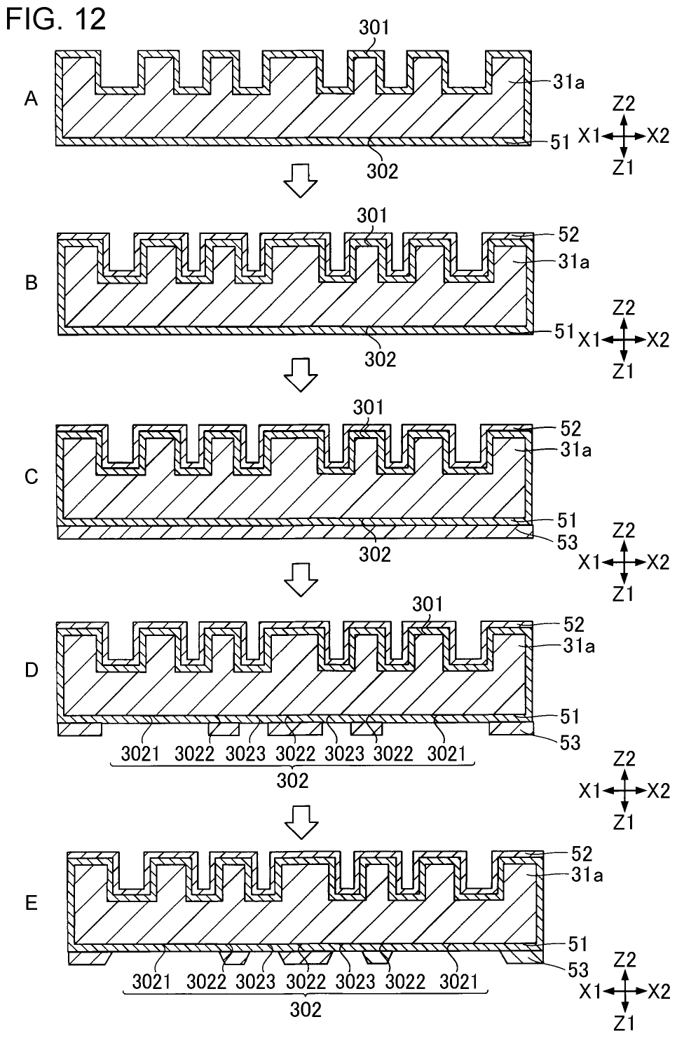

FIG. 12 is a diagram for explaining a process from the second oxide film forming step S20 to the second resist layer patterning step S23 illustrated in FIG. 11. In FIG. 12, A is a diagram for explaining the second oxide film forming step S20. As illustrated in A of FIG. 12, in the second oxide film forming step S20, a second oxide film 51 is formed at the entire outer surface region of the semiconductor substrate 31a. Specifically, the second oxide film 51 is a silicon oxide film. Therefore, the second oxide film 51 is formed at the first surface 301 and the second surface 302 of the semiconductor substrate 31a. For example, the second oxide film 51 is formed using a CVD method or a thermal oxidation method. The thickness of the second oxide film 51, though not specifically limited, is, for example, 0.2 μm or greater and 1.0 μm or less.

In FIG. 12, B is a diagram for explaining the second protection film forming step S21. As illustrated in B of FIG. 12, in the second protection film forming step S21, a second protection film 52 is formed at the first surface 301 of the semiconductor substrate 31a. Specifically, the second protection film 52 is formed on the second oxide film 51 formed on the first surface 301. The second protection film 52 is made of, for example, diamond-like carbon, a resist having high chemical resistance, or a composite of layers of them, etc. For example, the second protection film 52 is formed using a CVD method, a sputtering method, or a spin coat method.

In FIG. 12, C is a diagram for explaining the second resist layer forming step S22. As illustrated in C of FIG. 12, in the second resist layer forming step S22, a second resist layer 53 is formed at the second surface 302 of the semiconductor substrate 31a. Specifically, the second resist layer 53 is formed on the second oxide film 51 formed on the second surface 302. A resist is applied onto the second oxide film 51, and the second resist layer 53 is formed on the second oxide film 51 by using a centrifugal force. The thickness of the second resist layer 53, though not specifically limited, is, for example, 1 μm or greater and 3 μm or less.

In FIG. 12, each of D and E is a diagram for explaining the second resist layer patterning step S23. As illustrated in D of FIG. 12, in the second resist layer patterning step S23, the second resist layer 53 is patterned by removing a part of the second resist layer 53.

The second surface 302 of the semiconductor substrate 31a includes a fourth portion 3021, a fifth portion 3022, and a seventh portion 3023. The fourth portion 3021 is a portion corresponding to the communication space Ra, the common flow passage Rb, and the communication flow passages 314. The seventh portion 3023 is a portion corresponding to the communication flow passages 314. The fifth portion 3022 is a portion not corresponding to the communication flow passages 314 nor to the communication space Ra. The fourth portion 3021 and the seventh portion 3023 are portions to be removed by metal-assisted chemical etching to be described later. The fifth portion 3022 is a portion not to be removed by metal-assisted chemical etching.

In the second resist layer patterning step S23, the second resist layer 53 is patterned in such a way as to form an opening at the fourth portion 3021 and the seventh portion 3023 and not to form an opening at the fifth portion 3022.

As illustrated in E of FIG. 12, reflow baking is performed after the patterning of the second resist layer 53. As a result of this baking, the second resist layer 53 having been patterned is narrower at its Z1-side surface than at its Z2-side surface due to surface tension.

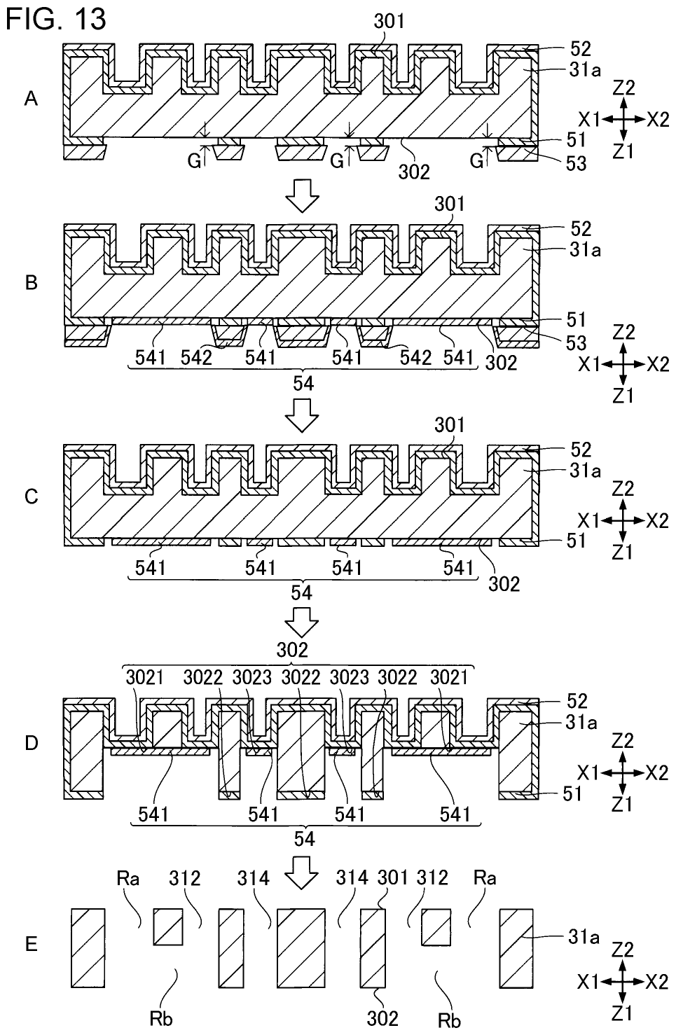

FIG. 13 is a diagram for explaining a process from the second oxide film etching step S24 to the metal-assisted chemical etching step S27 illustrated in FIG. 11.

In FIG. 13, A is a diagram for explaining the second oxide film etching step S24. As illustrated in A of FIG. 13, in the second oxide film etching step S24, the second oxide film 51 is patterned by etching a part of the second oxide film 51 away. For example, a part of the second oxide film 51 is removed by wet etching using buffered hydrofluoric acid, with the second resist layer 53 serving as a mask.

In the second oxide film etching step S24, a gap G is formed between the second surface 302 and the second resist layer 53. That is, in the second oxide film etching step S24, a part of the second oxide film 51 is removed to such an extent that the gap G is formed. In particular, when the semiconductor substrate 31a contains silicon, performing wet etching using hydrofluoric acid makes it easier to form the gap G.

In FIG. 13, B is a diagram for explaining the second metal film forming step S25. As illustrated in B of FIG. 13, in the second metal film forming step S25, a second metal film 54 is formed at the second surface 302 of the semiconductor substrate 31a. Specifically, the second metal film 54 is formed on the second resist layer 53 at the second surface 302. For example, film deposition of the second metal film 54 is performed using a sputtering method or the like. The second metal film 54 contains, for example, platinum, ruthenium, palladium, molybdenum, chromium, copper, tantalum, titanium, or iridium.

As described above, the gap G is formed between the second surface 302 and the second resist layer 53. For this reason, the second metal film 54 includes a portion(s) 541 that is in contact with the second surface 302 and a portion(s) 542 that is in contact with the second resist layer 53. Since the gap G is provided, the portion 541 is not continuous to the portion 542 and is thus separated therefrom.

In FIG. 13, C is a diagram for explaining the second resist layer removal step S26. As illustrated in C of FIG. 13, in the second resist layer removal step S26, the second resist layer 53 is removed. Simultaneously with this removal, the portion 542, of the second metal film 54, located on and in contact with the second resist layer 53 is also removed. As a result of this removal, the second metal film 54 made up of a plurality of portions 541 is formed at the second surface 302.

The second metal film 54 is formed on a surface at the fourth portion 3021 and the seventh portion 3023 and is not formed on a surface at the fifth portion 3022. Therefore, in a plan view, the second metal film 54 overlaps with the fourth portion 3021 and the seventh portion 3023 and does not overlap with the fifth portion 3022. In addition, the second metal film 54 is in contact with the fourth portion 3021 and the seventh portion 3023 and is not in contact with the fifth portion 3022.

In FIG. 13, each of D and E is a diagram for explaining the metal-assisted chemical etching step S27. As illustrated in D of FIG. 13, in the metal-assisted chemical etching step S27, a part of the semiconductor substrate 31a is removed by metal-assisted chemical etching. For example, metal-assisted chemical etching using a solvent containing hydrogen fluoride and an oxidizing agent is most suitable.

In metal-assisted chemical etching, oxidation of the semiconductor substrate 31a caused by a catalytic action of the material of the second metal film 54, etching of an oxide of the semiconductor substrate 31a by the solvent, and attraction due to the Coulomb force of the second metal film 54 and the semiconductor substrate 31a are repeated. It is possible to form a hole in the Z2 direction by repeating them.

As illustrated in E of FIG. 13, the second metal film 54 is removed after the removal of a part of the semiconductor substrate 31a. By this means, the remaining part of each communication flow passage 314 and the common flow passage Rb are formed in the semiconductor substrate 31a.

Through the above processes, the communication plate 31 that includes the narrowed portions 312, the communication flow passages 314, the common flow passage Rb, and the communication space Ra is manufactured.

As described earlier, the method of manufacturing the communication plate 31 includes the first step S1, in which the narrowed portions 312 are formed by performing metal-assisted chemical etching. In the first step S1, metal-assisted chemical etching is performed in a state in which the metal film 44 is formed at a surface of the first portion 3011 corresponding to the narrowed portions 312, the surface of the first portion 3011 being a part of the first surface 301 of the semiconductor substrate 31a, and the metal film 44 is not formed at a surface of the second portion 3012 not corresponding to the narrowed portions 312, the surface of the second portion 3012 being a part of the first surface 301 thereof. Therefore, the metal film 44 is formed in such a way as to be in contact with the first portion 3011 and not in contact with the second portion 3012.

Using metal-assisted chemical etching makes it possible to perform microfabrication of semiconductor through holes having a high aspect ratio and makes it possible to form the narrowed portions 312 with high fineness. Moreover, with metal-assisted chemical etching, it is possible to perform etching processing of many wafers in a batch and thus reduce processing time, whereas if dry etching is performed to process each wafer individually, very long processing time will be required, which might result in a decrease in productivity and efficiency of investment in vacuum equipment for manufacturing. Furthermore, with metal-assisted chemical etching, it is easier to form the narrowed portion 312 having a desired aspect ratio, whereas it is difficult to control an aspect ratio of the narrowed portion 312 when anisotropic wet etching along crystal orientation is performed. Therefore, using metal-assisted chemical etching makes it possible to form the narrowed portion 312 having a desired aspect ratio with high fineness. It is thus possible to realize the narrowed portion 312 having a micro structure as in the foregoing examples. Therefore, it is possible to control the behavior of a meniscus by the narrowed portion 312 and provide the liquid ejecting head 3 that is compact and offers excellent ejection performance.

As described earlier, the first step S1 includes the resist layer forming step S12, the resist layer patterning step S13, and the metal film forming step S15. In the resist layer forming step S12, the resist layer 43 is formed at the first surface 301 of the semiconductor substrate 31a. In the resist layer patterning step S13, after the forming of the resist layer 43, the resist layer 43 is patterned in such a way as to form an opening at the first portion 3011 and not to form an opening at the second portion 3012. In the metal film forming step S15, after the patterning of the resist layer 43, the metal film 44 is formed at the first surface 301.

Using the patterned resist layer 43 makes it possible to form the metal film 44 corresponding to the first portion 3011 while ensuring that the metal film 44 is never in contact with the surface of the second portion 3012, which is a non-etched area, even once, during the processes. That is, the disclosed flow makes it possible to form the metal film 44 at the target region only, without allowing metal to spread and remain in an atomic level anywhere except for the target region where the metal film 44 is to be formed.

As described earlier, the first step S1 includes the oxide film forming step S10 and the oxide film etching step S14. In the oxide film forming step S10, before the forming of the resist layer 43, the oxide film 41 is formed at the first surface 301. After that, in the resist layer forming step S12, the resist layer 43 is formed on the oxide film 41. In the oxide film etching step S14, after the patterning of the resist layer 43 but before the forming of the metal film 44, the oxide film 41 is etched, thereby opening a part of the oxide film 41, the part being on the first portion 3011.

Therefore, the oxide film 41 is formed between the first surface 301 and the resist layer 43. Forming the oxide film 41 makes it easier to remove the resist layer 43 from the oxide film 41 in a later step, that is, easier to pattern the metal film 44 on the first surface 301 by resist removal. Specifically, since each of the resist layer 43 and the oxide film 41 has an opening at the first portion 3011, it is easier to form the metal film 44 corresponding to the first portion 3011 as described earlier.

Furthermore, in the oxide film etching step S14, the gap G is formed between the first surface 301 and the resist layer 43 by etching the oxide film 41. Forming the gap G makes it easier to pattern the metal film 44 in a later step as compared with when the gap G is not formed. Since the gap G is provided, it is possible to separate the metal film 44 into the portion 441, which is in contact with the first surface 301, and the portion 442, which is in contact with the resist layer 43, at the time of film deposition of the metal film 44, and split the metal film 44 easily with its contour left clear at the time of removal of the resist layer 43.

The first step S1 includes the resist layer removal step S16. In the resist layer removal step S16, after the forming of the metal film 44 at the first surface 301, the resist layer 43 is removed. By removing the resist layer 43 as described earlier, the metal film 44 made up of the portions 441 is formed at the first surface 301. Therefore, it is possible to form the patterned metal film 44 easily. With this method, even when the metal film 44 has a very fine shape, it is possible to form the metal film 44 having a pattern of a desired shape and a desired arrangement easily with high precision.

In the first step S1, it is preferable if metal-assisted chemical etching is performed using a solvent containing hydrogen fluoride and an oxidizing agent. Using hydrogen fluoride makes it easier to remove the oxide of the semiconductor substrate 31a by etching. Using an oxidizing agent makes it possible to oxidize the semiconductor substrate 31a, with the metal film 44 serving as a catalyst. Therefore, it is possible to perform metal-assisted chemical etching efficiently.

Examples of the oxidizing agent, though not specifically limited, are a hydrogen peroxide solution (H₂O₂) and nitric acid (HNO₃). In order for the oxide of the semiconductor substrate 31a to form efficiently, the oxidizing agent may preferably be a hydrogen peroxide solution especially when the semiconductor substrate 31a contains silicon oxide. The type of the solvent is not limited to one containing hydrogen fluoride and an oxidizing agent.

As described earlier, the metal film 44 contains, for example, platinum, ruthenium, gold, palladium, molybdenum, chromium, copper, tantalum, titanium, or iridium. Among them, it is preferable if the metal film 44 is made of gold. The reason is that gold excels in catalytic reaction. Moreover, when the oxidizing agent contained in the solvent is a hydrogen peroxide solution, gold can fulfill catalytic reaction well.

The semiconductor substrate 31a is not specifically limited as long as it is a substrate containing a semiconductor material; however, a silicon substrate is preferred, or more preferably, an N-type monocrystalline silicon substrate. Adopting the N type makes it possible to perform metal-assisted chemical etching efficiently through the action of carrier electrons. Moreover, even at a high etching rate, it is less likely that surface roughness will be formed, and the quality is thus high.

As described earlier, in the first step S1, the narrowed portions 312 and the communication space Ra are formed by performing metal-assisted chemical etching in a state in which the metal film 44 is formed at, of the first surface 301, the third portion 3013 corresponding to the communication space Ra, in addition to the first portion 3011. When metal-assisted chemical etching is performed, unlike dry etching, a difference in etching rate ascribable to a difference in size of planar compartment forming area of an etching pattern, that is, a micro-loading effect, does not arise; therefore, it is possible to easily and speedily form the narrowed portions 312 and the communication space Ra in a batch uniformly. That is, it is possible to form holes that differ in cross-sectional area parallel to an X-Y plane easily and speedily in a batch. For this reason, it is possible to make the processing time shorter.

The method of manufacturing the communication plate 31 includes the second step S2, in which the common flow passage Rb is formed by performing metal-assisted chemical etching. In the second step S2, metal-assisted chemical etching is performed in a state in which the second metal film 54 is formed at a surface of the fourth portion 3021 corresponding to the common flow passage Rb, the surface of the fourth portion 3021 being a part of the second surface 302 of the semiconductor substrate 31a, and the second metal film 54 is not formed at a surface of the fifth portion 3022 not corresponding to the common flow passage Rb, the surface of the fifth portion 3022 being a part of the second surface 302 thereof. Therefore, the second metal film 54 is formed in such a way as to be in contact with the fourth portion 3021 and not in contact with the fifth portion 3022.

Using metal-assisted chemical etching makes it possible to form the common flow passage Rb that is in communication with the communication space Ra and with the narrowed portions 312 as a flow passage in a stacked structure body, with a free planar shape, with high fineness. Therefore, the liquid ejecting head 3 that is compact and offers excellent ejection performance can be realized.

In the method of manufacturing the communication plate 31, the first step S1 and the second step S2 are executed in this order to directly connect the narrowed portions 312 and the common flow passage Rb. Using metal-assisted chemical etching realizes processing with high positional precision. Therefore, by processing the first surface 301 and the second surface 302 in order, it is possible to connect the narrowed portions 312 and the common flow passage Rb directly in a batch and connect the common flow passage Rb and the communication space Ra directly.

### 2. Second Embodiment

Next, a second embodiment will now be explained. In the embodiment described below, the same reference numerals as those used in the above description of the first embodiment are assigned to elements that are the same in operation and/or function as those in the first embodiment, and a detailed explanation of them is omitted.

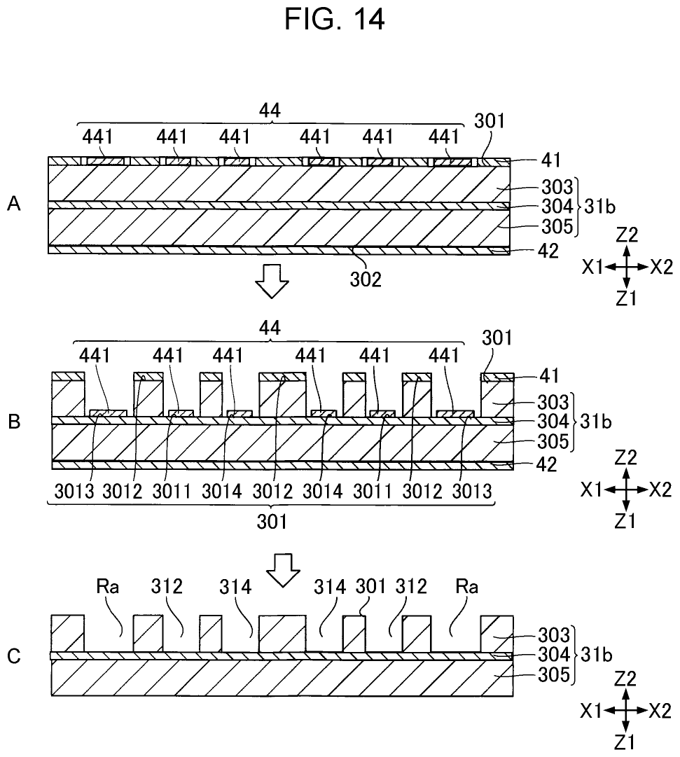

FIG. 14 is a diagram for explaining the first step S1 according to a second embodiment. FIG. 14 illustrates the resist layer removal step S16 and the metal-assisted chemical etching step S17. In the present embodiment, an SOI substrate is used as a semiconductor substrate 31b. The specifications of the SOI substrate are not specifically limited. For example, the semiconductor substrate 31b is a stacked body made up of a 100-crystal-oriented N-type monocrystalline silicon substrate 303, a silicon oxide film 304, and a 110-crystal-oriented P-type monocrystalline silicon substrate 305. Configuring the specifications of the SOI substrate as in this example makes it possible to process more uniform vertical silicon holes by MACE in the 100-crystal-oriented N-type monocrystalline silicon substrate 303 of the SOI substrate and perform high-fineness silicon groove processing by anisotropic wet etching with its flow passage walls configured as 111 planes in the 110-crystal-oriented P-type monocrystalline silicon substrate 305. Therefore, the specifications of the SOI substrate that enable optimum silicon processing with desired fabrication of shape and dimensions of each flow passage can be adopted.

In FIG. 14, A is a diagram for explaining the resist layer removal step S16; a state after the removal of the resist layer 43 is illustrated therein. The metal film 44 made up of the plurality of portions 441 is formed at the first surface 301 by removing the portion 442, which is a part of the metal film 44, on the resist layer 43 together with the resist layer 43 as in the first embodiment.

In FIG. 14, each of B and C is a diagram for explaining the metal-assisted chemical etching step S17. As illustrated in B of FIG. 14, similarly to the first embodiment, the N-type monocrystalline silicon substrate 303, which is a part of the semiconductor substrate 31b, is removed by metal-assisted chemical etching. This metal-assisted chemical etching is performed until reaching the silicon oxide film 304. As illustrated in C of FIG. 14, the metal film 44 is removed after the removal of the part of the semiconductor substrate 31b. By this removal, similarly to the first embodiment, each narrowed portion 312, a part of each communication flow passage 314, and the communication space Ra are formed in the semiconductor substrate 31b.

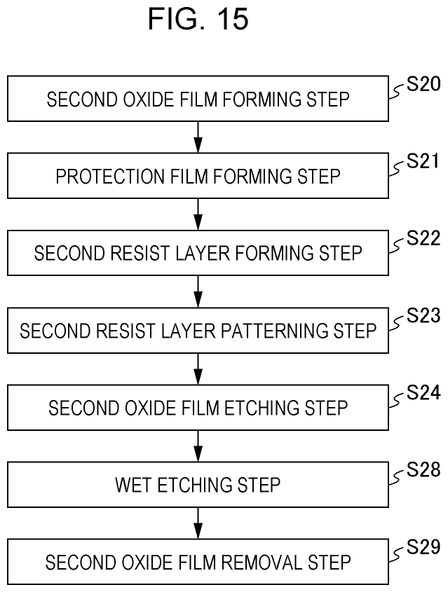

FIG. 15 is a diagram illustrating a flow of the second step S2 according to the second embodiment. In FIG. 15, the second step S2 according to the second embodiment includes a wet etching step S28 and a second oxide film removal step S29 in place of the second metal film forming step S25, the second resist layer removal step S26, and the metal-assisted chemical etching step S27. In the present embodiment, the second protection film forming step S21 may be omitted.

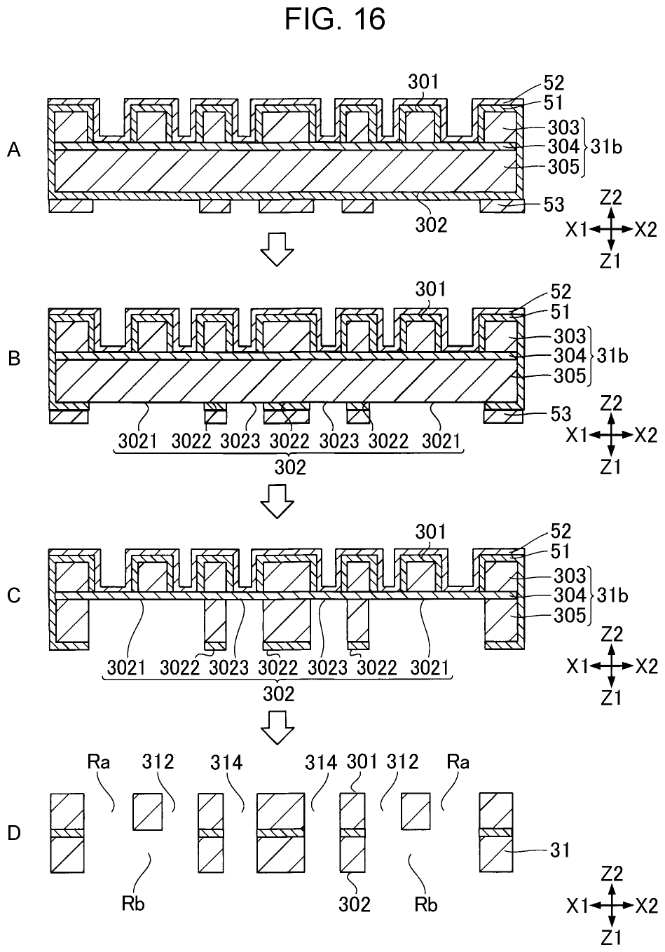

FIG. 16 is a diagram for explaining the second step S2 according to the second embodiment. In FIG. 16, A is a diagram for explaining the second resist layer patterning step S23. Prior to this step, the second oxide film 51 is formed at the entire outer surface region of the semiconductor substrate 31b as in the first embodiment. After that, the second protection film 52 is formed on the second oxide film 51 formed on the first surface 301. After that, the second resist layer 53 is formed on the second oxide film 51 formed on the second surface 302. After that, in this step, the second resist layer 53 is patterned by removing a part of the second resist layer 53.

The second surface 302 of the semiconductor substrate 31b includes the fourth portion 3021, the fifth portion 3022, and the seventh portion 3023 as in the first embodiment. In the second resist layer patterning step S23, the second resist layer 53 is patterned in such a way as to form an opening at the fourth portion 3021 and the seventh portion 3023 and not to form an opening at the fifth portion 3022. In the present embodiment, reflow baking is omitted.

In FIG. 16, B is a diagram for explaining the second oxide film etching step S24. As illustrated in B of FIG. 16, in the second oxide film etching step S24, the second oxide film 51 is patterned by etching a part of the second oxide film 51 away. For example, a part of the second oxide film 51 is removed by wet etching using buffered hydrofluoric acid, with the second resist layer 53 serving as a mask. The second resist layer 53 is removed after the patterning of the second oxide film 51.

In this step, the second oxide film 51 does not exist on the fourth portion 3021 nor on the seventh portion 3023 and exists on the fifth portion 3022. Therefore, in a plan view, the second oxide film 51 does not overlap with the fourth portion 3021 nor with the seventh portion 3023 and overlaps with the fifth portion 3022.

In FIG. 16, C is a diagram for explaining the wet etching step S28. In the wet etching step S28 illustrated in C of FIG. 16, for example, the P-type monocrystalline silicon substrate 305, which is a part of the semiconductor substrate 31b, is removed by wet etching using potassium hydroxide.

In FIG. 16, D is a diagram for explaining the second oxide film removal step S29. As illustrated in D of FIG. 16, the second oxide film 51 is removed after the removal of the part of the semiconductor substrate 31b. Simultaneously with the removal of the second oxide film 51, a part of the silicon oxide film 304 of the semiconductor substrate 31b is removed. For example, the second oxide film 51 and a part of the silicon oxide film 304 are removed by wet etching using buffered hydrofluoric acid. By this removal, each narrowed portion 312, the remaining part of each communication flow passage 314, and the communication space Ra are formed in the semiconductor substrate 31b.

Through the above processes, the communication plate 31 that includes the narrowed portions 312, the communication flow passages 314, the common flow passage Rb, and the communication space Ra is manufactured.

As described earlier, in the second step S2, wet etching is performed in a state in which the second oxide film 51 is not formed at, of the second surface 302 of the semiconductor substrate 31b, the fourth portion 3021 corresponding to the common flow passage Rb, and the second oxide film 51 is formed at, of the second surface 302, the fifth portion 3022 not corresponding to the common flow passage Rb. As a result of this etching, the common flow passage Rb is formed. The cross-sectional area of the common flow passage Rb in the Z1 direction is larger than the cross-sectional area of the narrowed portion 312 in the Z1 direction. For this reason, it is possible to form flow passages by high-fineness flow passage walls using crystalline anisotropic wet etching without using metal-assisted chemical etching suited for microfabrication. Therefore, it is possible to form the common flow passage Rb easily and speedily and form the flow passage structure body 30 that includes the narrowed portions 312 by using an optimum flow passage forming method that is the best for each flow passage structure.

In addition, since each etching is stopped by the silicon oxide film 304 of the SOI substrate, the dimensions in the direction along the Z axis can be determined by the thickness of each of the monocrystalline silicon substrates 303 and 305 that constitute the SOI substrate and, therefore, it is possible to form flow passages with high precision in passage dimensions by making the thickness precision of the SOI substrate high. That is, it is possible to form the narrowed portion 312 with high precision in length in the Z1 direction, achieving high-precision flow passage resistance fabrication. At the same time, it is possible to form the common flow passage Rb with high precision in depth in the Z2 direction and realize the flow passage structure body 30 that is compact and high in precision.

### 3. Third Embodiment

Next, a third embodiment will now be explained. In the embodiment described below, the same reference numerals as those used in the foregoing description of the first embodiment are assigned to elements that are the same in operation and/or function as those in the first embodiment, and a detailed explanation of them is omitted.

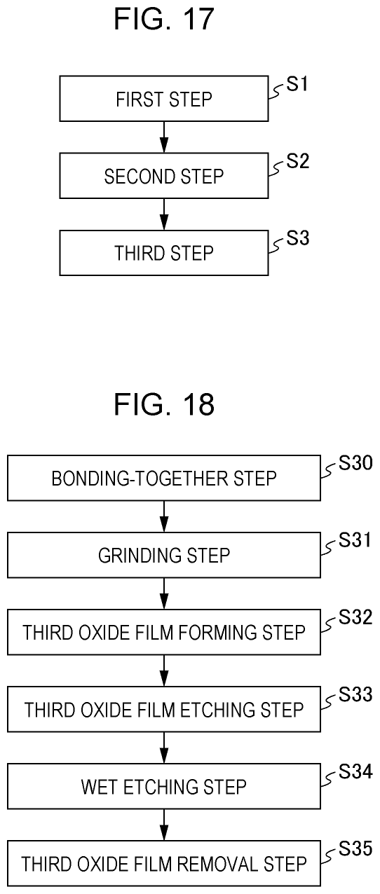

FIG. 17 is a diagram illustrating a flow of a method of manufacturing the communication plate 31 according to a third embodiment. As illustrated in FIG. 17, the present embodiment further includes a third step S3. In the first step S1, similarly to the first embodiment, each narrowed portion 312, a part of each communication flow passage 314, and the communication space Ra are formed in the semiconductor substrate 31a. Though not illustrated, in the second step S2, a semiconductor substrate 31c that is not the semiconductor substrate 31a is prepared. Then, in the second step S2, similarly to the first embodiment, the remaining part of each communication flow passage 314 and the common flow passage Rb are formed in the semiconductor substrate 31c.

FIG. 18 is a diagram illustrating a flow of the third step S3 according to the third embodiment. As illustrated in FIG. 18, the third step S3 includes a bonding-together step S30, a grinding step S31, a third oxide film forming step S32, a third oxide film etching step S33, a wet etching step S34, and a third oxide film removal step S35.

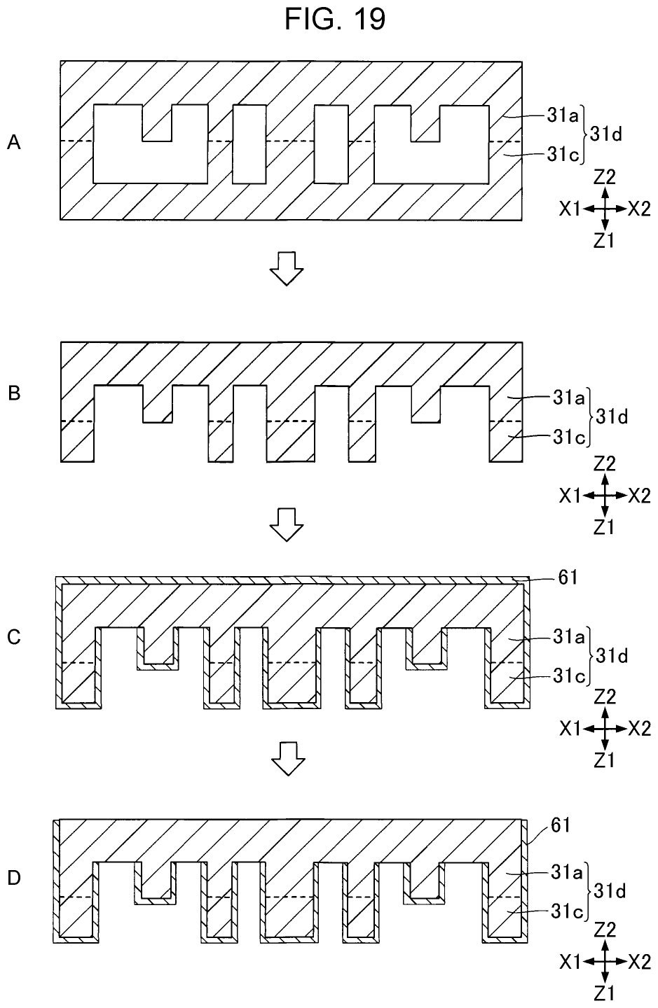

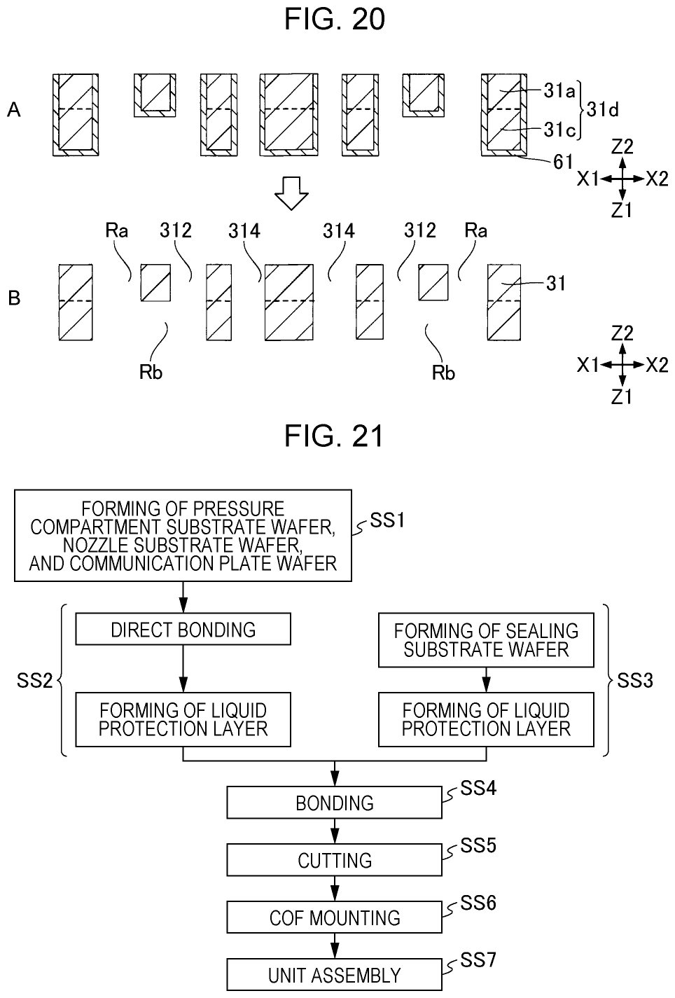

Each of FIGS. 19 and 20 is a diagram for explaining the third step S3 according to the third embodiment. In FIG. 19, A is a diagram for explaining the bonding-together step S30. As illustrated in A of FIG. 19, in the bonding-together step S30, a structure body 31d is formed by bonding the semiconductor substrate 31a of the first step S1 and the semiconductor substrate 31c of the second step S2 together. For example, when each of the semiconductor substrates 31a and 31c is a silicon substrate, they are bonded together using direct silicon bonding.

In FIG. 19, B is a diagram for explaining the grinding step S31. As illustrated in B of FIG. 19, in the grinding step S31, grinding is performed from the semiconductor-substrate-(31c) side of the structure body 31d. By this grinding, a part of the structure body 31d is removed.

In FIG. 19, C is a diagram for explaining the third oxide film forming step S32. As illustrated in C of FIG. 19, in the third oxide film forming step S32, a third oxide film 61 is formed at the outer surface of the structure body 31d. For example, the third oxide film 61 is formed by means of thermal oxidation.

In FIG. 19, D is a diagram for explaining the third oxide film etching step S33. As illustrated in D of FIG. 19, in the third oxide film etching step S33, the third oxide film 61 formed at the semiconductor-substrate-(31a)-side surface of the structure body 31d is removed by etching. For example, buffered hydrofluoric acid is used for the removal.

In FIG. 20, A is a diagram for explaining the wet etching step S34. As illustrated in A of FIG. 20, in the wet etching step S34, for example, the semiconductor-substrate-(31a)-side portion of the structure body 31d is removed by wet etching using potassium hydroxide, with the third oxide film 61 serving as a mask.

In FIG. 20, B is a diagram for explaining the third oxide film removal step S35. As illustrated in B of FIG. 20, in the third oxide film removal step S35, for example, the third oxide film 61 is removed by wet etching using buffered hydrofluoric acid. Through the above processes, the communication plate 31 that includes the narrowed portions 312, the communication flow passages 314, the common flow passage Rb, and the communication space Ra is manufactured.

Metal-assisted chemical etching is used in the first step S1 and the second step S2 in the present embodiment, too. Therefore, it is possible to form the narrowed portions 312 with high fineness.

### 4. Method of Manufacturing Liquid Ejecting Head 3

FIG. 21 is a diagram illustrating a flow of a method of manufacturing the liquid ejecting head 3. As described earlier, the liquid ejecting head 3 includes the pressure compartment substrate 32 including the pressure compartments C1, the communication plate 31 stacked on the pressure compartment substrate 32 and including the narrowed portions 312 and the common flow passage Rb, and the nozzle substrate 37 stacked on the communication plate 31 and including the nozzles N. In the example of the first embodiment, the communication plate 31 is formed of the semiconductor substrate 31a.

In the example illustrated in FIG. 21, in a step SS1, each of a pressure compartment substrate wafer including a plurality of pressure compartment substrates 32, a nozzle substrate wafer including a plurality of nozzle substrates 37, and a communication plate wafer including a plurality of communication plates 31 is formed individually. In a step SS2, these wafers are directly bonded together. After that, a liquid protection layer is formed on wall surfaces constituting each flow passage including the narrowed portion 312 and the common flow passage Rb. The liquid protection layer may be formed before direct bonding. In a step SS3, a sealing substrate wafer including a plurality of sealing substrates 35 is formed, and a liquid protection layer is formed on each flow passage including the communication space Ra and the like.

The liquid protection layer mentioned above contains, for example, tantalum oxide or hafnium oxide. The chemical formula of tantalum oxide is TaO_{X}. The chemical formula of hafnium oxide is HfO_{X}. The liquid protection layer is formed using, for example, an atomic layer deposition (ALD) method.

In a step SS4, the sealing substrate wafer is bonded to the pressure compartment substrate wafer, the nozzle substrate wafer, and the communication plate wafer, thereby manufacturing a structural object that includes these wafers. In a step SS5, the structural object is cut into chips using a laser scriber or the like. In a step SS6, the chips are COF-mounted on a mount pad. COF is an acronym for Chip On Film. After that, in a step SS7, the vibration absorber 38, the casing portion 36, and case parts such as ink tube parts are assembled using an adhesive or the like. The liquid ejecting head 3 can be obtained through these steps.

### 5. Variation Example

The embodiments described as examples above can be modified in various ways. Some specific examples of modification that can be applied to the embodiments described above are described below. Two or more modification examples selected arbitrarily from the description below may be combined as long as they are not contradictory to each other or one another.

The liquid ejecting head 3 may be a so-called circulation-type head. In this case, the liquid ejecting head 3 further includes a circulation mechanism 26. In addition, in this case, the narrowed portion 312 functioning as a supply port in the foregoing embodiments may function as a discharge port.

Though the metal film 44 is formed using a sputtering method or the like in the foregoing embodiments, the metal film 44 may be formed using a non-electrolytic plating method. In this case, film deposition of the oxide film 41 may be omitted. A resist film is used as a mask.

The liquid ejecting apparatus 1 disclosed as examples in the first embodiment can be applied to not only print-only machines but also various kinds of equipment such as facsimiles and copiers, etc. The scope of application and use of the liquid ejecting apparatus is not limited to printing. For example, a liquid ejecting apparatus that ejects a colorant solution can be used as an apparatus for manufacturing a color filter of a display device such as a liquid crystal display panel. A liquid ejecting apparatus that ejects a solution of a conductive material can be used as a manufacturing apparatus for forming wiring lines and electrodes of a wiring substrate. A liquid ejecting apparatus that ejects a solution of a living organic material can be used as a manufacturing apparatus for, for example, production of biochips.

What is claimed is:

1. A method of manufacturing a liquid ejecting head including a plurality of individual flow passages and a common flow passage, each of the plurality of individual flow passages including a pressure compartment extending in a first direction, a nozzle being in communication with one end of the pressure compartment, and a narrowed portion being in communication with an other end of the pressure compartment and extending in a second direction intersecting with the first direction and being smaller in sectional area than the pressure compartment, the common flow passage being in shared communication with the plurality of individual flow passages, the method comprising:
a first step of forming the narrowed portion by performing metal-assisted chemical etching in a state in which a metal film is formed at a surface of a first portion corresponding to the narrowed portion, the surface of the first portion being a part of a first surface of a semiconductor substrate, and the metal film is not formed at a surface of a second portion not corresponding to the narrowed portion, the surface of the second portion being a part of the first surface.

2. The method of manufacturing a liquid ejecting head according to claim 1, wherein
the first step includes
forming a resist layer at the first surface,
after forming the resist layer, patterning the resist layer to form an opening at the first portion and not to form an opening at the second portion, and
after patterning the resist layer, forming the metal film at the first surface.

3. The method of manufacturing a liquid ejecting head according to claim 2, wherein
before forming the resist layer, forming an oxide film at the first surface,
forming the resist layer at the oxide film, and
opening a part of the oxide film, the part being on the first portion, by etching the oxide film after patterning the resist layer but before forming the metal film.

4. The method of manufacturing a liquid ejecting head according to claim 3, wherein
a gap is formed between the first surface and the resist layer by etching the oxide film.

5. The method of manufacturing a liquid ejecting head according to claim 2, wherein
in the first step, the resist layer is removed after forming the metal film at the first surface.

6. The method of manufacturing a liquid ejecting head according to claim 1, wherein
in the first step, the metal-assisted chemical etching is performed using a solvent containing hydrogen fluoride and an oxidizing agent.

7. The method of manufacturing a liquid ejecting head according to claim 1, wherein
the metal film is made of gold.

8. The method of manufacturing a liquid ejecting head according to claim 1, wherein
the liquid ejecting head further includes a communication space extending in the second direction and communicating the common flow passage with an external flow passage, and
in the first step, the narrowed portion and the communication space are formed by performing the metal-assisted chemical etching in a state in which the metal film is formed at, of the first surface, a third portion corresponding to the communication space, in addition to the first portion.

9. The method of manufacturing a liquid ejecting head according to claim 1, further comprising:
a second step of forming the common flow passage by performing metal-assisted chemical etching in a state in which a second metal film is formed at a surface of a fourth portion corresponding to the common flow passage, the surface of the fourth portion being a part of a second surface of the semiconductor substrate, the second surface being an opposite of the first surface, and in which the second metal film is not formed at a surface of a fifth portion not corresponding to the common flow passage, the surface of the fifth portion being a part of the second surface.

10. The method of manufacturing a liquid ejecting head according to claim 9, wherein
the first step and the second step are executed in this order to directly connect the narrowed portion and the common flow passage.

11. The method of manufacturing a liquid ejecting head according to claim 1, further comprising:
a second step of forming the common flow passage by performing wet etching in a state in which a second oxide film is not formed at, of a second surface of the semiconductor substrate, a fourth portion corresponding to the common flow passage, the second surface being an opposite of the first surface, and in which the second oxide film is formed at, of the second surface, a fifth portion not corresponding to the common flow passage.

12. The method of manufacturing a liquid ejecting head according to claim 1, wherein
the liquid ejecting head further includes
a pressure compartment substrate including the pressure compartment,
a communication plate stacked on the pressure compartment substrate and including the narrowed portion and the common flow passage, and
a nozzle substrate stacked on the communication plate and including the nozzle, and
the communication plate is formed of the semiconductor substrate.
